(19) United States
(12) Patent Application Publication
(10) Pub. No.: US 2004/0256345 A1
(43) Pub. Date: Dec. 23, 2004

(54) Single use recyclable infant feeding bottle

(76) Inventor: Jon Tyler Lundquist, Chandler, AZ (US)

Correspondence Address: LAWRENCE N. GINSBERG, 21 SAN ANTONIO, NEWPORT BEACH, CA, 92660-9112, US

(21) Appl. No.: 10/600,628

(22) Filed: Jun. 20, 2003

(51) Int. Cl. A61J 9/04; A61J 11/02; A61J 9/00; A61J 11/00; A61J 9/08

(52) U.S. Cl. 215/11.5; 215/11.1; 215/11.6

(57) ABSTRACT

A single use recyclable infant feeding bottle is provided for easy use with virtually eliminated or substantially reduced risk of contamination. The single use recyclable infant feeding bottle of the invention comprises a container with a container lip having an outer securing hook and an inner securing rib, and an integrated assembly that has a teat and a sealing cap in a single piece. The sealing cap has a snap-on feature that engages with the container lip. Thus, the single use recyclable infant feeding bottle can be easily assembled by putting the integral assembly and the container together through the snap-on feature. Moreover, moulding the teat and sealing cap into one piece makes the manufacture process of the single use recyclable infant feeding bottle efficient and economical.

### FIELD OF THE INVENTION

The present invention relates to a feeding bottle and more particularly to a single use recyclable infant feeding bottle that has an integrated assembly featuring a teat and a sealing cap with a snap-on feature, so that the single use recyclable infant feeding bottle can be manufactured efficiently and economically.

### BACKGROUND OF THE INVENTION

A conventional feeding bottle generally comprises a container, a cap and a nipple. The nipple is nested in the cap and the nipple tip is projected over the bottle. The cap and the container are threaded onto each other through the preset inner and outer threads thereon. The container, cap and nipple are reusable. A standard nipple is commonly made of either natural or synthetic rubber, both of which are flexible and compressible. An opening in the tip end of the nipple permits liquid to be withdrawn from the container in response to a sucking action by a feeding infant.

Reusable feeding bottles are major sources of concern for parents and other care givers. The feeding bottles must be properly cleansed and sterilized in order to prevent introduction of harmful contaminants into infant formula and other beverages to be consumed by the infant. The sterilization process is time consuming; moreover, the bottle preparer may fail to clean a reusable bottle thoroughly and thereby placing the infant at risk.

Different disposable bottles have been designed for resolving or attenuating the problem of contamination. For example, U.S. Pat. No. 5,579,935 discloses a disposable container made of plastic film that is deployed within a container shell. The open end of the disposable container folds across an end of the container shell and is secured by a flexible rubber nipple which clamps the disposable container in place. In this feeding system, the container is disposable but the nipple and the shell are reusable. U.S. Pat. No. 6,138,847 discloses a disposable non-reusable baby bottle that includes a container having a rigid flange at the container's open end, a nipple having a radially enlarged flange, and a snap ring which locks the nipple to the open end of the container. Once the baby bottle is assembled, the snap ring prevents the nipple from being disassembled from the container. Furthermore, PCT WO 02074227 discloses a single-use feed bottle that has a body to be sealed in a fluid tight manner by means of a closure and a teat.

The market demands that a single use recyclable infant feeding bottle be cost-effective and user-friendly. However, these available designs with multiple pieces suffer one or more of the problems including the complexity of using, inefficiency of manufacture, and prohibitive cost. Therefore, there is a need to have a simple single use recyclable infant feeding bottle that can be not only used easily and hygienic but also manufactured efficiently and economically.

### SUMMARY OF THE INVENTION

The present invention relates to a single use recyclable infant feeding bottle. More specifically, the single use recyclable infant feeding bottle of the present invention has an integrated assembly that features a teat and a sealing cap in one piece. The sealing cap has a snap-on feature that provides a user-friendly closure means for a leak proof seal. The single use recyclable infant feeding bottle of the present invention is so designed to minimize risk of contamination, to lower per unit cost, and to be manufactured efficiently and economically.

In accordance with the forgoing, the present invention provides a single use recyclable infant feeding bottle that comprises a container for holding liquid and an integral assembly for providing a teat and a snap-on feature to engage with the container. The container has a container lip that includes an outer securing hook and an inner securing rib, thereby forming first half of the snap-on feature. The integral assembly features a teat for sucking and a sealing cap for receiving the teat and engaging with the container. The sealing cap features a sealing lip that has an inner annular flange with a circumvential hump and an outer annular flange with a locking flange, thereby forming second half of the snap-on feature. When the single use recyclable infant feeding bottle is assembled through the snap-on feature, the circumvential hump engages with the inner securing rib to form a leak proof seal for preventing the liquid from discharging, and, at the same time, the locking flange engages with the outer securing hook to reinforce the leak proof seal and prevent the disengagement of the container and integral assembly.

Accordingly, one object of the present invention is to provide a feeding bottle that can be easily assembled for a single use, so that the possibility of contamination is virtually or substantially eliminated.

Another object of the present invention is to provide a feeding bottle that can be manufactured easily in two pieces, so that the single use recyclable infant feeding bottle is cheap.

The objects and advantages of the invention will become apparent from the following detailed description of preferred embodiments thereof in connection with the accompanying drawings in which like numerals designate like elements.

### BRIEF DESCRIPTION OF THE DRAWINGS

FIG. 1 is a front elevational view of the single use recyclable infant feeding bottle;

FIG. 2 is a top plan view of the single use recyclable infant feeding bottle;

FIG. 3 is an exploded, elevational perspective view of the single use recyclable infant feeding bottle;

FIG. 4 is a front sectional elevational view of the single use recyclable infant feeding bottle according to section A-A in FIG. 2;

FIG. 5 is an enlarged partial sectional view of the snap assembly;

FIG. 6 is an enlarged partial sectional view of the vent;

FIG. 7 is an enlarged partial sectional view of the top of the teat; and

FIG. 8 is an enlarged partial upside-down view of the sealing cap.

### DETAILED DESCRIPTION OF THE DRAWINGS

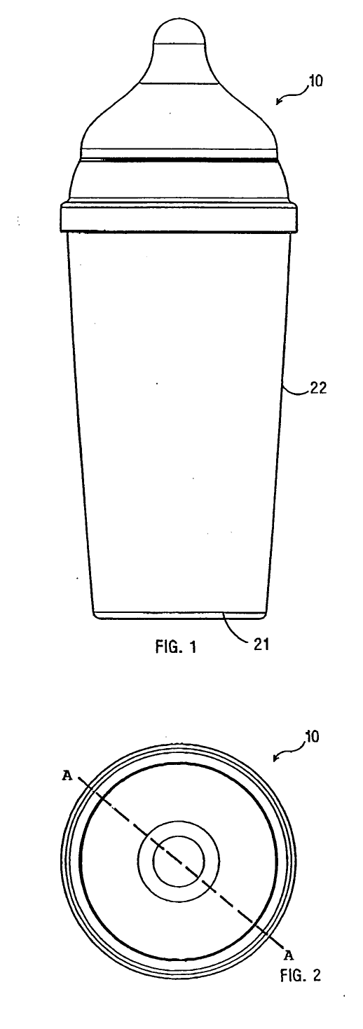

Referring now to the drawings in detail wherein like reference numerals have been used throughout the various figures to designate like elements, there is shown in FIG. 1 a single use recyclable infant feeding bottle constructed in accordance with the principles of the present invention and designated generally as 10.

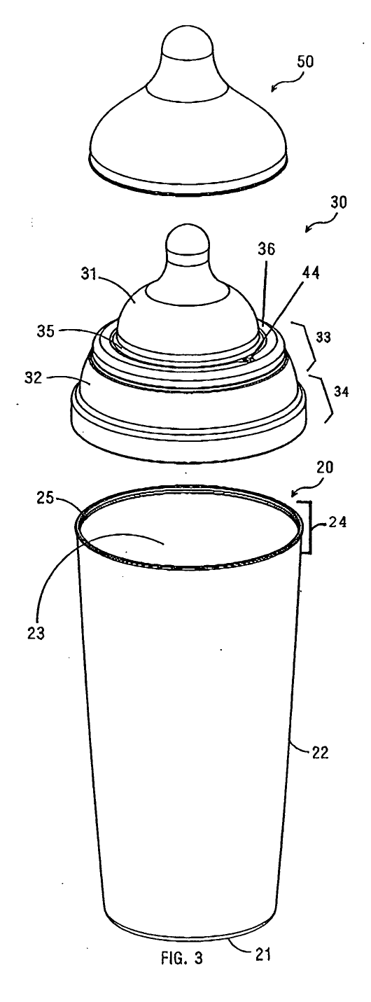

Referring now to FIGS. 1-3, the single use recyclable infant feeding bottle 10 as shown comprises a container 20, an integrated assembly 30, and a teat cover 50. The container 20 has a bottom face 21 and a peripheral side wall 22. The peripheral side wall 22 is integrally coupled to and extending upwardly from the bottom face 21 for defining an interior space 23. The shape of the peripheral side wall 22 could be any known to anyone skilled in the art. A cylindrical shape is exemplarily illustrated in FIG. 3. The interior space 23 holds any liquid including milk, juice, water, and formula. The peripheral side wall 22 ends up with an open end portion 24 with a container lip 25. The container lip 25 provides means for assembling the single use recyclable infant feeding bottle 10.

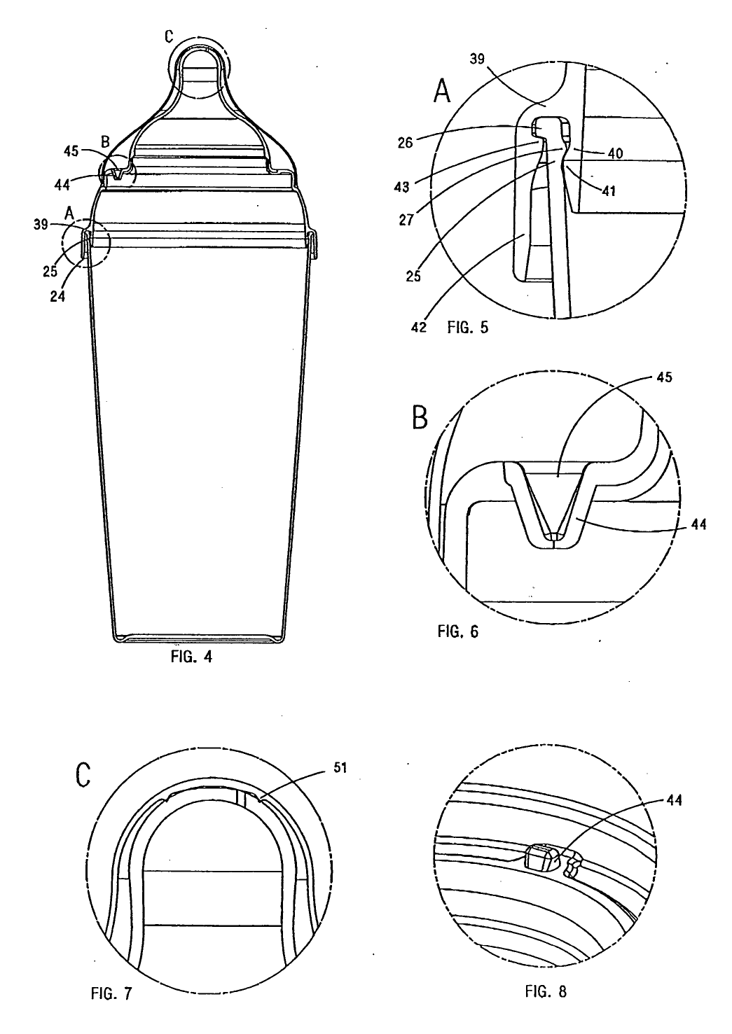

Referring now to FIGS. 4 and 5, the container lip 25 is engaged with a sealing lip 39 of a sealing cap 32, which will be discussed in detail later. The container lip 25 has an outer securing hook 26 that extends outwardly from the container lip 25. The outer securing hook 26 could be an outward extension of the tip of the container lip 25 as illustrated in FIG. 5. It is known to anyone skilled in the art that the outer securing hook 26 is not limited to be disposed at the tip of the container lip 25. The container lip 25 also has an inner securing rib 27 that extends inwardly from the container lip 25. The inner securing rib 27 is spaced down further from the outer securing hook 26 of the container lip. The container may be made of plastic, polypropylene, polycarbonate, polystyrene, or polyethylene.

Referring still to FIG. 3, the integrated assembly 30 has a teat 31 and a sealing cap 32. The teat 31 is a standard teat, which is defined herein to mean a feeding teat of the type commonly used with reusable baby bottles utilizing screw-on caps. Standard teats are commonly made of either natural or synthetic rubber, both of which are flexible and compressible. In certain embodiments, the teat 31 is made of thermoplastic elastomer. The teat 31 may be made of latex or silicon. The teat 31 has an outwardly peripheral extension 35 that extends from its base. In certain embodiments, the outwardly peripheral extension 35 is integrally moulded with the sealing cap 32.

When an infant suckles on a bottle to draw liquid therefrom through a teat, the withdrawal of liquid produces a partial vacuum within the bottle. As the pressure differential increases, it becomes extremely difficult for the suckling to draw liquid from the bottle. Thus, referring now to FIGS. 3, 4, 6 and 8, in certain embodiments, a valve 44 is integrally disposed onto the edge of the outwardly peripheral extension 35 of the teat 31. The valve 44 may be moulded with the teat 31 at the same time. The valve 44 has an opening at its tip within the container 20 to allow the air into the container 20 when an infant suckles the feeding bottle 10. The valve 44 may be made of thermoplastic elastomer. The valve 44 may be any one known to the person skilled in the art including disk-shaped valve, various diaphragms and one-way valves.

Referring now to FIG. 3, the sealing cap 32 has a frusto-conical configuration. For the convenience of description, the sealing cap 32 is arbitrarily designated with an upper portion 33 and a lower portion 34. The upper portion 33 of the sealing cap 32 has a top surface 36. The inner edge of the top surface is upwardly extended so as to form an upwardly extension for allowing the liquid in the container flow to the teat. An annular recession is also formed on the top surface 36. The annular recession is so formed outwardly from the upwardly extension such that it receives the outwardly peripheral extension 35 of the teat 31. Now still referring to FIG. 3 in combination with FIGS. 6 and 8, the top surface 36 has a vent hole 45 for receiving the valve 44.

Referring still to FIG. 3 in combination with FIGS. 4 and 5, the lower portion 34 of the sealing cap 32 has a sealing lip 39. The sealing lip 39 has an inner annular flange 40 extending downwardly from the end tip of the lower portion 34 and having a circumvential hump 41 for engaging with the inner securing rib 27 of the container 20 to form a leak proof seal for preventing the liquid from discharging from the container. The sealing lip 39 also has an outer annular flange 42 extending outwardly first and then downwardly from the end tip of the lower portion 34 and having a locking flange 43 inwardly extending horizontally from the outer annular flange with a lower angularly disposed shoulder surface. The locking flange 43 engages with the outer securing hook 26 of the container so as to reinforce the leak proof seal formed between the circumvential hump 41 and the inner securing rib 27. The outer annular flange 42 is spaced from the inner annular flange 40 so as to receive the container lip 25. In certain embodiments, the inner annular flange 40 may be comprised of three or four segments that are equally spaced. The sealing cap may be made of plastic, polypropylene, polycarbonate, polystyrene, or polyethylene

Referring to FIGS. 3, 4 and 7, the single use recyclable infant feeding bottle 10 may optionally include a teat cover 50. The teat cover 50 is so disposed onto the top of the integral assembly 30 as to protect the teat 31 from contact with external environment when the teat is not suckled by the infant. The teat cover 50 is especially useful when the integral assembly 30 is held by a hand during the process of assembly of the single use recyclable infant. Referring now particularly to FIG. 7, the teat cover 50 has an annular rib 51 formed on its inner surface. Thereby, when the teat cover engages with the sealing cap 32, the annular rib 51 presses against the top of the teat to provide further protection of the teat from leaking or exposing its sucking holes from external environment. The teat cover 50 may be made of plastic, polycarbonate, polystyrene, or polyethylene.

It is apparent now that the single use recyclable infant feeding bottle of the present invention is easily assembled for use. When needed, one could pour liquid into the container 20 first, then snap-on the integral assembly 30 with or without the teat cover 50 onto the container. Thus, the single use recyclable infant feeding bottle is ready for use. Also, the single use recyclable infant feeding bottle is reduced essentially into two pieces, the container and the integral assembly. This design makes the manufacturing process efficient and economical. Thus, the single use recyclable infant feeding bottle could be offered at a very competitive price.

While the foregoing has presented descriptions of certain preferred embodiments of the present invention, it is to be understood that these descriptions are presented by way of example only and are not intended to limit the scope of the present invention. It is expected that others skilled in the art will perceive variations which, while differing from the foregoing, do not depart from the spirit and scope of the invention as herein described and claimed.

What is claimed is:

1. A single use recyclable infant feeding bottle comprising:
a container including a bottom face and a peripheral side wall integrally coupled thereto and extending upwardly therefrom for defining an interior space for holding liquid and forming an open end with a container lip, wherein the container lip includes an outer securing hook extending outwardly from the container lip and an inner securing rib extending inwardly from the container lip and spacing further from the outer securing hook of the container lip; and
an integral assembly including a teat for sucking and a sealing cap with a frusto-conical configuration having an upper portion and a lower portion; wherein the teat has an outwardly peripheral extension at its base; wherein the upper portion of the sealing cap includes a top surface, an upwardly extension extending from the inner edge of the top surface and forming a center for allowing the liquid in said container flow to the teat, and an annular recession formed on the top surface outwardly from the upwardly extension for receiving the outwardly peripheral extension of the teat; and wherein the lower portion of the sealing cap includes a sealing lip having an inner annular flange extending downwardly from the end tip of the lower portion and having a circumvential hump for engaging with the inner securing rib of said container to form a leak proof seal for preventing the liquid from discharging from said container, and an outer annular flange extending outwardly at first and then downwardly from the end tip of the lower portion and having a locking flange inwardly extending horizontally from said outer annular flange with a lower angularly disposed shoulder surface for engaging with the outer securing hook of said container, the outer annular flange spaced from the inner annular flange as to receive the container lip;
thereby, when said integral assembly engages with said container, a single use recyclable infant feeding bottle is provided that is for a single use.

2. The single use recyclable infant feeding bottle of claim 1, further comprising an elastomeric valve integrally disposed onto the edge of the outwardly peripheral extension of the teat; wherein the top surface of the upper portion of the sealing cap having a vent hole for receiving the elastomeric valve of the teat.

3. The single use recyclable infant feeding bottle of claim 1, further comprising a teat cover for preventing the teat from contacting with external environment; wherein the teat cover engages with the sealing cap.

4. The single use recyclable infant feeding bottle of claim 3, wherein the teat cover has an annular rib formed on its inner surface; thereby, when the teat cover engages with the sealing cap, the annular rib of the teat cover presses against the top surface of the teat to provide further protection of the teat from leaking or exposing its sucking holes from external environment.

5. The single use recyclable infant feeding bottle of any of claims 1-5, wherein the teat and valve are made of a material selected from the group consisting of thermoplastic elastomer, latex and silicon.

6. The single use recyclable infant feeding bottle of any of claims 1-5, wherein the sealing cap, the teat cover and the container are made of a material selected from the group consisting of plastic, polypropylene, polycarbonate, polystyrene, and polyethylene.

7. A single use recyclable infant feeding bottle comprising:
a container including a bottom face and a peripheral side wall integrally coupled thereto and extending upwardly therefrom for defining an interior space for holding liquid and forming an open end with a container lip, wherein the container lip includes an outer securing hook extending outwardly from the container lip and an inner securing rib extending inwardly from the container lip and spacing further from the outer securing hook of the container lip; and
an integral assembly including a teat for sucking and a sealing cap with a frusto-conical configuration having an upper portion and a lower portion; wherein the teat has an outwardly peripheral extension at its base and an elastomeric valve integrally disposed onto the edge of the outwardly peripheral extension of the teat; wherein the upper portion of the sealing cap includes a top surface with a vent hole for receiving the elastomeric valve of the teat, an upwardly extension extending from the inner edge of the top surface and forming a center for allowing the liquid in said container flow to the teat, and an annular recession formed on the top surface outwardly from the upwardly extension for receiving the outwardly peripheral extension of the teat; and wherein the lower portion of the sealing cap includes a sealing lip having an inner annular flange extending downwardly from the end tip of the lower portion and having a circumvential hump for engaging with the inner securing rib of said container to form a leak proof seal for preventing the liquid from discharging from said container, and an outer annular flange extending outwardly at first and then downwardly from the end tip of the lower portion and having a locking flange inwardly extending horizontally from said outer annular flange with a lower angularly disposed shoulder surface for engaging with the outer securing hook of said container, the outer annular flange spaced from the inner annular flange as to receive the container lip;
thereby, when said integral assembly engages with said container, a single use recyclable infant feeding bottle is provided that is for a single use.
